(19) United States
(12) Patent Application Publication
(10) Pub. No.: US 2007/0272851 A1
(43) Pub. Date: Nov. 29, 2007

(54) Device for modifying and/or rebalancing ionisation for an electrical load

(76) Inventors: Demetrio Paolo Iero, Reggio Calabria (IT); Giuseppe Di Loreto, Velletri (IT); Adriana Pesante, Frascati (IT)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/489,862

(22) Filed: Jul. 19, 2006

(30) Foreign Application Priority Data
Jul. 19, 2005 (EP) 05425516.1

(51) Int. Cl. H01J 49/00

(52) U.S. Cl. 250/288

(57) ABSTRACT

A device for modifying and/or rebalancing ionization in a fluid environment, both gaseous and liquid, capable of rebalancing some vital function of biological matter contained in the fluid environment itself, applicable to an electrical load powered by an electrical power source; the device is provided with a pair of inputs designed to be connected to the electrical power source, a pair of outputs designed to be connected to the electrical load, and at least one pair of electrical conductive elements mutually crossingly arranged and electrically insulated one from the other so that each is extended between an input (2) and a respective output and is crossed by at least one part of an electrical current absorbed by the electrical load.

The present invention relates to a device for modifying and/or rebalancing ionization for an electrical load.

In particular, the present invention finds advantageous, although not exclusive, application in an electrical load of the domestic or industrial type in order to modify and/or rebalance the ionization of a fluid environment both gaseous and liquid, and consequently, rebalancing some vital functions of biological material contained in the fluid environment itself in presence of an electromagnetic field produced by the electrical load itself, to which the following description refers without for this losing in generality.

### BACKGROUND OF THE INVENTION

It has been scientifically demonstrated for several years that air ionization, that is the concentration of positive and negative ions in gaseous form in the air, influences the cellular biological activities in living organisms.

In the air of natural outdoor environments, as in the mountains or in the open countryside, there are normally present high concentration of negative ions and low concentrations of positive ions.

In closed environments, instead, the concentration of both positive and negative ions is typically lower, due to the poor exchange of fresh air, and the percentage of positive ions may also be more than double with respect to the percentage of negative ions. Indeed, buildings of the modern type often contain metallic structures and coverings of synthetic type, on which are accumulated positive electrostatic charges capable of absorbing a large amount of negative ions.

Furthermore, it has been demonstrated that alternating electromagnetic fields generated by electrical loads for domestic or industrial purposes, combining with the terrestrial magnetic field, unfavorably modify the concentration ratio of positive and negative ions. More precisely, considering a vectorial representation of the magnetic fields, the vector associated to the magnetic component of the alternating electromagnetic field generated by an electrical load arranges parallelly to the vector associated to the terrestrial static magnetic field.

In particular, the exposure of biological material, which belongs to a human, animal or vegetable organism or to a microorganism, to a combination of parallel magnetic fields of weak intensity, one static and one alternating, may determine a transient variation of flow of certain biological ionic species through the cellular membranes of the biological material itself. This variation in particular occurs when the frequency of the alternating magnetic field becomes the same as the so-called “cyclotron frequency” of such ionic species, altering in general the metabolism of the organism to which the biological material belongs. Such effect known in the scientific environment as the “Blackman-Liboff-Zhadin effect”, is essentially theorized and described in the following texts:
A. R. Liboff <<Cyclotron resonance in membrane transport>> in <<Interactions between electromagnetic fields and cells>>, A. Chiabrera et al., Plenum Press (1985), pages 281-296;
<<A role for the magnetic field in the radiation induced efflux of calcium ions from brain tissue in vitro>>, C. F. Blackman et al., Bioelectromagnetics 6 (1985), pages 327-337; and
<<Combined action of static and alternating magnetic fields on ionic currents in aqueous glutamic acid solution>>, M. N. Zhadin et al., Bioelectromagnetics 19 (1998), pages 41-45.

Finally, it is scientifically recognized that when a living organism, such as a human, animal or vegetable organism, or a microorganism, remains exposed for al long time to a high percentage of positive ions, with respect to a natural total concentration of negative and positive ions, it undergoes metabolic alterations, for example an alteration of the sodium-potassium pump function which governs the so-called “cellular respiration”, feeding, in the specific case of the human and animal organisms, a series of muscular, dermatological, respiratory, rheumatic, cardiological, psychiatric and psychological pathologies.

The ratio between the concentration of negative ions and the concentration of positive ions in a natural environment therefore represents a desirable intended ionization balance to prevent feeding the aforesaid pathologies.

Generally, the excess of positive ions in a closed environment is solved with the use of specific ionization apparatuses capable of outputting electrons which negatively charge the molecules of oxygen and nitrogen present in the air thus forming negative ions.

However, this solution is disadvantageous from an economic point of view, because typically one ionization device must be used for each closed environment. Furthermore, a possible centralized ionization system which produces and distributes, by means of specific pipings, negative ions to several environments would present the further drawback of producing an accumulation of electrostatic positive charges along the walls of the pipings caused by the flow of the air along the pipings themselves, which accumulation causes a corresponding absorption of a large amount of the produced negative ions.

### SUMMARY OF THE INVENTION

It is the object of the present invention to provide a device for modifying and/or rebalancing ionization of a fluid environment, both gaseous and liquid, capable of rebalancing some vital function of biological material contained in the fluid environment itself, applicable to any electrical or electronic load, which device solves the aforementioned drawbacks and, at the same time, is easy and cheap to make. According to the present invention, there is provided a device for modifying and/or rebalancing ionization for an electrical load as claimed in the attached claims.

### BRIEF DESCRIPTION OF THE DRAWINGS

For a better understanding of the present invention, there will now be described preferred embodiments, only by way of non-limitative example and with reference to the accompanying drawings, in which:

FIG. 1 schematically shows a first preferred embodiment of the device for modifying and/or rebalancing ionization according to the present invention;

FIG. 2 schematically shows a second preferred embodiment of the device for modifying and/or rebalancing ionization according to the present invention;

FIG. 3 schematically shows a third preferred embodiment of the device for modifying and/or rebalancing ionization according to the present invention;

FIG. 4 shows, according to a perspective view, an embodiment of a detail of the device for modifying and/or rebalancing ionization according to the present invention;

FIG. 5 shows, according to a perspective exploded view, an embodiment of a detail of the device for modifying and/or rebalancing ionization of FIG. 3; and

FIGS. 6 and 7 show tables and charts gathering measurements made on two examples of biological material culture exposed to the electromagnetic field of an electrical load connected, and not connected, to the device for modifying and/or rebalancing ionization of FIG. 1.

### DETAILED DESCRIPTION OF THE INVENTION

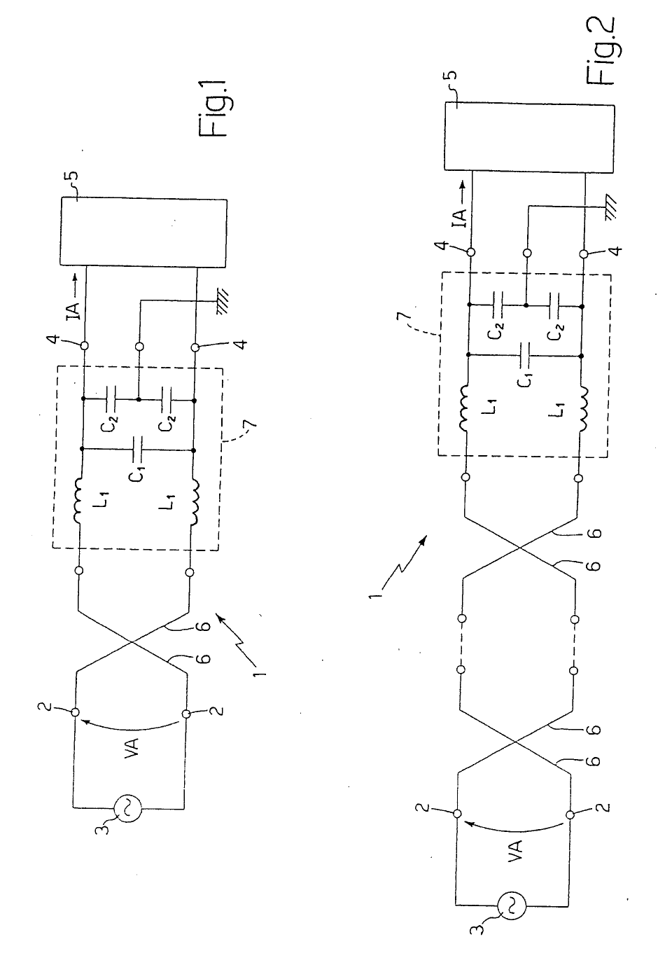

In FIG. 1, number 1 indicates, by means of a principle electric diagram, a first preferred embodiment of a device for modifying and/or rebalancing ionization comprising a pair of inputs 2 designed to be connected to an electrical power source 3; a pair of outputs 4 designed to be connected to an electrical load 5; a pair of electrical conductive elements 6 mutually crossingly arranged without reciprocal contact, or by interposing between them an electrically insulating material (not shown), and in such a manner that each of the two electrical conductive elements 6 extends between an input 2 and a respective output 4; and an electrical filter 7 of the passive type connected between the pair of electrical conductive elements 6 and the pair of outputs 4 to remove interference signals from the electrical energy source 3.

For electrical load 5 it is hereinafter intended a generic electrical load consisting, for example, of a household appliance, an electrical tool, a television set, a cellular telephone or any other apparatus which needs alternating or direct electrical power to operate, or of a combination in series or in parallel of a plurality of the aforementioned apparatuses. Consequently, the electrical power source 3 is of the alternating or, respectively, direct type, and the electrical filter 7 is of the type operating on alternating current or on direct current, respectively.

The electrical conductive elements 6 are made of a same electrical conductive material, for example metal, metallic alloy, and in particular silver alloy, superconductor material, conducting rubber or the like, or by two different electrical conductive materials, for example two different metals or metallic alloys, or superconductor materials. The electrical conducting elements 6 are of the solid or stranded type according to the type of material with which they are made. The value of the section area of the electrical conductive elements 6 depends on a nominal electrical power value absorbed by the electrical load 5 and whether it is solid or stranded.

Furthermore, the electrical conductive elements 6 preferably, but not necessarily, present a straight shape, define, by mutually crossing, a certain angle, preferably equal to 90 degrees, and lay on a certain plane 8, as shown in FIG. 4. As shown in FIG. 1, the device 1 is applied to an electrical load 5 operating on alternating current and the electrical filter 7 consists of a passband double-n filter dimensioned to operate at a frequency from 50 to 60 Hz, at a maximum electrical voltage amplitude value equal to 240 V and a maximum current amplitude value equal to 6 A. In particular, the electrical filter 7 comprises a pair of inductances L1, each equal to 2.1 mH, a capacitance C1 equal to 0.1 pF (350 V of maximum applicable voltage), and a pair of capacitances C2, each equal to 3300 pF (350 V of maximum applicable voltage).

The device 1 comprises a support (not shown) on which the electrical conductive elements 6 and the electrical filter 7 are mounted. In actual use, the support of device 1 is positioned so as to orient, with respect to the ground, the plane 8 on which the pair of electrical conductive elements 6 lay according to a certain angulation, and in particular equal to 90 degrees. Once activated, the electrical power source 3 applies an alternating electrical voltage VA on the inputs 2 of the device 1, which is consequently crossed by at least one part of an alternating electrical current IA absorbed by the electrical load 5 and depending on the nominal electrical power absorbed by the electrical load 5. The electrical conductive elements 6, while they are crossed by said part of the electrical current IA, reverse, due to their crossed arrangement, the electrical voltage present at the input of the electrical filter 7 with respect to that applied to the pair of inputs 2, thus preventing the vector of the magnetic component of the alternating electromagnetic field generated by the electrical load 5 from arranging itself parallelly to the vector of the terrestrial magnetic field.

FIG. 2 shows a second preferred embodiment of the device 1 which differs from the first preferred embodiment shown in FIG. 1 in that it comprises a plurality of said pairs of electrical conductive elements 6 mutually cascadingly connected between the inputs 2 and the outputs 4. In other words, each electrical conductive element 6 of each upstream pair is electrically connected in series to a respective electrical conductive element 6 of the downstream pair so that each pair of electrical conductive elements 6 is crossed, in use, by said part of electrical current IA.

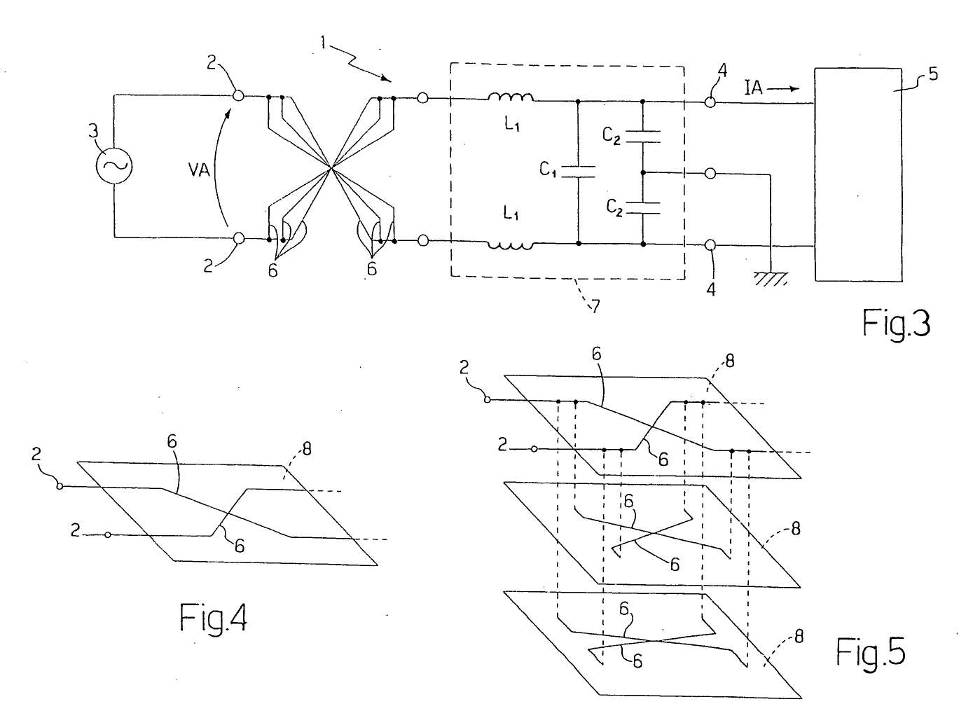

FIG. 3 shows a third preferred embodiment of the device 1 which differs from the first preferred embodiment shown in FIG. 1 in that it comprises a plurality of said electrical conductive elements 6, and in particular three pairs of electrical conductive elements 6, mutually electrically connected in parallel between the inputs 2 and the outputs 4 so as to be crossed, in use, by respective fractions of said part of the electrical current IA.

In particular, with reference to the exploded perspective view shown in FIG. 5, the pairs of electrical conductive elements 6 lay on respective mutually parallel and electrically isolated planes 8 according to a “wafer” structure and the two electrical conductive elements 6 of each pair define, by mutually crossing, a relative angle. The angles defined by the pairs of electrical conductive elements 6 assume respective mutually different values and are determined so as to remove as much as possible the magnetic component of the electromagnetic field generated by the electrical load 5 from the abovementioned condition of parallelism with the terrestrial magnetic field. A fourth preferred embodiment of the device 1 (not shown) differs from the embodiments previously described and shown in FIGS. 1, 2, 3 and 4 in that the electrical filter 7 is connected between the pair of inputs 2 and the electrical conductive elements 6.

A fifth embodiment of the device 1 (not shown) differs from the previously described embodiments in that the electrical filter 7 is of the active type. Such type of electrical filter 7 avoids that possible interference signals produced by the electrical load 5 are transmitted to the electrical power source 3.

The efficacy of device 1 in modifying and rebalancing the ionization in a fluid environment will be explained in the following description of some non-limiting examples by way of example only. In particular, the following examples show how the use of the device 1, and in particular of device 1 shown in FIG. 1, leads to a surprising vitality of inoculated microorganisms in appropriate liquid environments which were exposed to the electromagnetic field of an electrical load 5 consisting of an incandescent bulb.

### EXAMPLE 1

A culture broth of the known type manufactured by Oxoid was inoculated with a yeast, and in particular with Rhodotorula Rubra, to form a biological material solution. The solution was exposed to the continuous light of an incandescent bulb with power of 40 W, powered from the mains with a voltage of 220 V at 50 Hz, and placed at a distance of approximately 10 cm from the solution itself.

The purpose of the bulb was to heat the solution to maintain a favorable environment for the reproduction of the inoculated microorganism.

Two tests were conducted on respective identical quantities of such solution: in a first test A, the bulb was connected directly to the mains power and in a second test B, the lamp was connected to device 1, which was connected to mains power and was placed at a distance of approximately 40 cm from the solution.

Tests A and B were conducted at the same time in respective rooms, arranged at a distance of 10 metres one from the other, and lasted for a total period of seven days. For each of the tests A, B, analyses were performed at the beginning of exposure (t=0 hours), after four days from the beginning (t=96 hours) and after seven days from the beginning (t=168 hours) to measure the pH of the solution and to determine the Total Microbial Count.

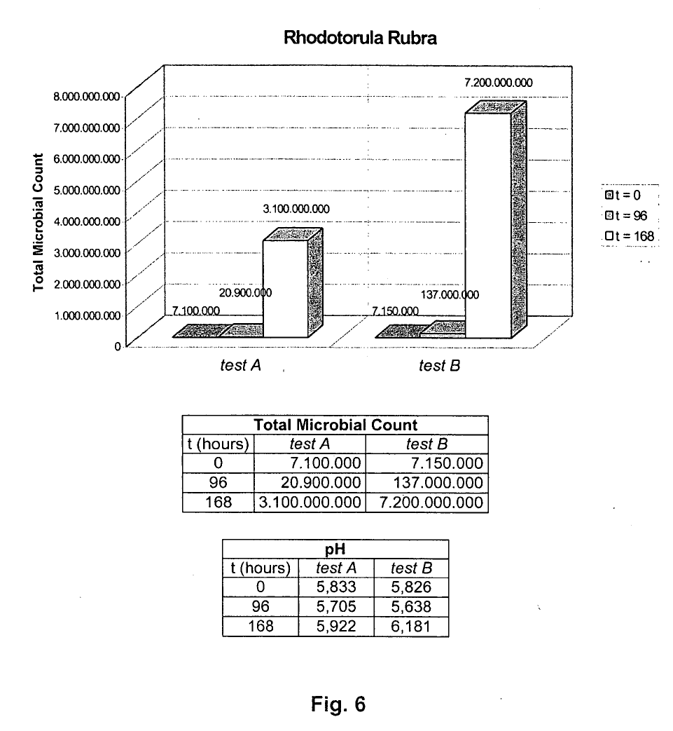

Finally, tests A, B were repeated twenty times over a six month period in order to obtain an arithmetical average of the pH and Total Microbial Count determinations for each exposure time to the lamp. Such averages were collected in two tables shown in FIG. 6.

With particular reference to the Total Microbial Count, also shown in the bar chart in FIG. 6, it is observed that the use of device 1 (test B) favors the development of yeast in time, creating the conditions for a considerably higher growth rate with respect to the absence of device 1 itself (test A). The increased growth rate reaches a maximum value for an exposure time of 96 hours, in which the Total Microbial Count of test B is equal to more than six times that of test A. At an exposure time of 168 hours, the Total Microbial Count increase was lower because the life conditions of the yeast are worsened by the saturation of the closed environment, in which the yeast grows, constituted by the quantity of solution chosen for tests A and B.

### EXAMPLE 2

This example differs from example 1 in that the culture broth is inoculated with a bacterium, and in particular with Bacillus Subtilis.

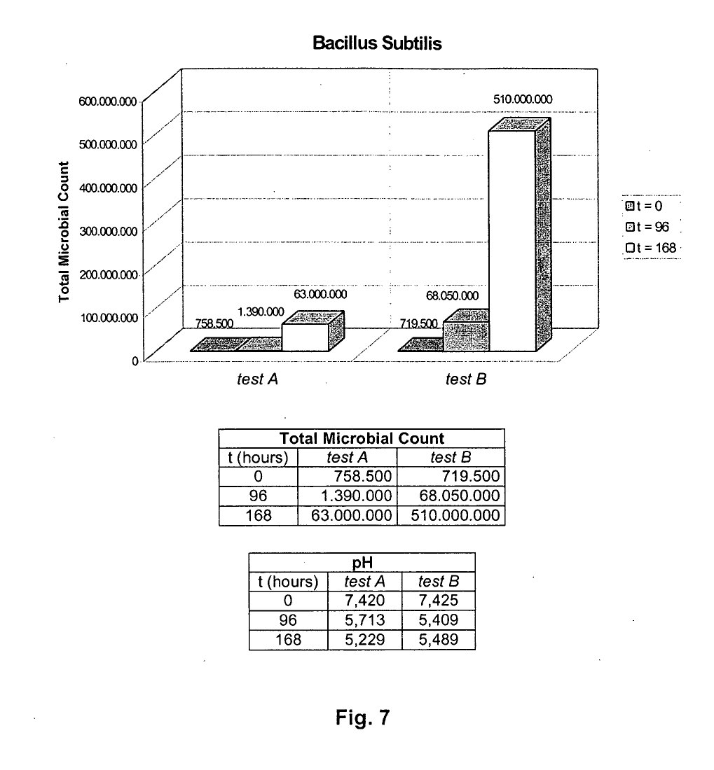

FIG. 7 shows the tables with the average measurements of pH and Total Microbial Count performed with the bacterium and a bar chart of the Total Microbial Count in the two tests A, B. Also in this example, the use of device 1 produces a considerably higher growth rate of the bacteria. In particular, the increased growth rate reaches a surprising peak for the exposure time of 96 hours, in which the Total Microbial Count of test B is equal to approximately fifty times that on test A. Also tests A, B related to Bacillus Subtilis were repeated twenty times over a six months period to obtain an arithmetical average of the pH and Total Microbial Count measurements for each exposure time to the lamp.

From both examples, it is deduced that the use of device 1 influences the movements of ionic species on the basis of the metabolism of microorganisms in the culture broth so as to considerably increase the vitality of the microorganisms themselves. For movements of ionic species we intend those described by the aforementioned “Blackman-Liboff-Zhadin effect”.

The main advantage of all the embodiments of the device 1 described above, when connected to an electrical load 5 in operation, is in limiting at the source the ionic imbalance inside a closed fluid environment, both gaseous and liquid, exposed to the electrical load 5 itself is located, modifying and/or rebalancing, in such a manner, the ionization of the fluid environment towards a more natural ratio of negative ion concentration and positive ion concentration.

Furthermore, the device 1 is easy and cheap to make and presents reduced dimensions such as to possibly permit an easy integration inside the electrical load 5. In particular, the extreme building simplicity of the device 1 make it possible to build it by means of different techniques, such as the printed circuit technique, the integrated circuit technology or the nanotechnology.

What is claimed is:

1. A device for modifying and/or rebalancing ionization for an electrical load (5), which is powered by an electrical power source (3); the device (1) being characterized in that it comprises at least one pair of electrical conductive elements (6) configured so as to be crossed, in use, by at least one part of an electrical current (IA) absorbed by the electrical load (5), mutually crossingly arranged and electrically insulated one with respect to the other.

2. A device according to claim 1, comprising a pair of inputs (2) and a pair of outputs (4); the pair of inputs (2) being designed to be connected to said electrical power source (3) and the pair of outputs (4) being designed to be connected to said electrical load (5).

3. A device according to claim 2, in which each electrical conductive element (6) is extended between an input (2) of said pair of inputs (2) and a respective output (4) of said pair of outputs (4).

4. A device according to claim 1, in which said electrical conductive elements (6) present a straight shape.

5. A device according to claim 1, comprising a plurality of said pairs of electrical conductive elements (6) mutually cascadingly connected such that each of said pairs is crossed by said part of the electrical current (IA) absorbed by said electrical load (5).

6. A device according to claim 1, comprising a plurality of said pairs of electrical conductive elements (6) mutually electrically connected in parallel such that each of said pairs is crossed by a respective fraction of said part of the electrical current (IA) absorbed by said electrical load (5).

7. A device according to claim 6, in which said pairs of electrical conductive elements (6) lay on respective mutually parallel planes (8).

8. A device according to claim 5, in which said electrical conductive elements (6) present a straight shape; the two electrical conductive elements (6) of each of said pairs of electrical conductive elements (6) defining an angle; the angle of each pair of electrical conductive elements (6) being different from the angle of any other pair of electrical conductive elements (6).

9. A device according to claim 1, in which said electrical-conductive elements (6) are made of a same electrical conductive material.

10. A device according to claim 1, in which each of said pairs of electrical conductive elements (6) comprises a first electrical conductive element (6) and a second electrical conductive element (6); the first and the second electrical conductive elements (6) are each made of a respective electrical conductive material; the electrical conductive material of the first electrical conductive element (6) being different from the electrical conductive material of the second electrical conductive element (6).

11. A device according to claim 9, in which said electrical conductive material is chosen from a group of materials consisting in:
metal;
metallic alloy;
conducting rubber; and
superconductor material.

12. A device according to claim 2, comprising at least one electrical filter (7) arranged between said pair of inputs (2) and said pairs of electrical conductive elements (6).

13. A device according to claim 2, comprising at least one electrical filter (7) arranged between said pairs of electrical conductive elements (6) and said pair of outputs (4).

14. A device according to claim 4, in which each of said pairs of electrical conductive elements (6) lay on a respective plane (8); the device (1) being adapted to be positioned so as to orient the plane (8) orthogonally with respect to the ground.

15. A device according to claim 12, in which said electrical filter (7) is of the passive type.

16. A device according to claim 15, in which said electrical filter (7) of the passive type comprises a double-n passband filter.

17. A device according to claim 12, in which said electrical filter (7) is of the active type.

18. A device according to claim 1, and built by means of printed circuit technique.

19. A device, according to claim 1, and built by means of miniaturization techniques.

20. An electrical load (5) provided with a device for modifying and/or rebalancing ionization (1) according to claim 1.
